(19) United States
(12) Patent Application Publication
(10) Pub. No.: US 2026/0228488 A1
(43) Pub. Date: Aug. 6, 2026

(54) INFORMATION PROCESSING APPARATUS, METHOD FOR CONTROLLING INFORMATION PROCESSING APPARATUS, AND STORAGE MEDIUM

(71) Applicant: CANON KABUSHIKI KAISHA, Tokyo (JP)

(72) Inventor: TAKAYUKI KOMATSU, Kanagawa (JP)

(21) Appl. No.: 19/450,492

(22) Filed: Jan. 15, 2026

(30) Foreign Application Priority Data
Feb. 3, 2025 (JP) 2025-016303

(51) Int. Cl. G06N 3/044

(52) U.S. Cl. CPC G06N 3/044

(57) ABSTRACT

An information processing apparatus that performs inference processing using a neural network, the information processing apparatus includes an inference processing unit configured to perform the inference processing using a plurality of pieces of input data including an image and sound as inputs, and an acquisition unit configured to obtain information about a zoom state in capturing of the image, wherein the inference processing unit controls the inference processing using at least one of the plurality of pieces of input data based on the obtained information about the zoom state.

### BACKGROUND

### Field of the Technology

The present disclosure relates to an information processing apparatus, a method for controlling the information processing apparatus, and a storage medium.

### Description of the Related Art

The deep learning technology using a neural network is applied across a wide range of technical fields including classification that recognizes and then classifies images. A widely used convolutional neural network (CNN) performs high-accuracy deep learning processing by repeatedly performing convolutional operations on images.

Further, a technique of performing deep learning processing using a plurality of types of (multimodal) information has been described. Japanese Patent Laid-Open No. 2023-46127 describes a technique of receiving images and sound associated with speech from one or more speakers, and then inferring the speech content of a specific speaker out of the one or more speakers using as inputs two types of information: lip features calculated from the images and sound features calculated from the sound.

The technique described in Japanese Patent Laid-Open No. 2023-46127 is described as a configuration based on the assumption that a sound source (a speaker) is in close proximity to a device that collects images and sound, such as in a small meeting. However, in cases where the imaging range varies from short to long distances, such as capturing images by a monitoring camera or wild bird photography, the distance from a device to a subject differs depending on the subject selected by the user. In such cases, when the subject is positioned at a long distance from the device, in the technique described in Japanese Patent Laid-Open No. 2023-46127, inference is performed using sound emitted from an object different from the subject, leading to deterioration of the inference accuracy.

### SUMMARY

According to an aspect of the present disclosure, an information processing apparatus that performs inference processing using a neural network, the information processing apparatus includes an inference processing unit configured to perform the inference processing using a plurality of pieces of input data including an image and sound as inputs, and an acquisition unit configured to obtain information about a zoom state in capturing of the image, wherein the inference processing unit controls the inference processing using at least one of the plurality of pieces of input data based on the obtained information about the zoom state.

Features of the present disclosure will become apparent from the following description of embodiments with reference to the attached drawings. The following description of embodiments is described by way of example.

### BRIEF DESCRIPTION OF THE DRAWINGS

FIG. 1 is a diagram illustrating a hardware configuration example of an information processing apparatus.

FIG. 2 is a diagram illustrating a functional configuration example of the information processing apparatus.

FIG. 3 is a diagram illustrating a configuration example of an inference processing unit according to one or more aspects of the present disclosure.

FIG. 4 is a table for describing selection of an inference model for a state according to one or more aspects of the present disclosure.

FIG. 5 is a flowchart illustrating a processing example of the information processing apparatus according to one or more aspects of the present disclosure.

FIG. 6 is a diagram illustrating a configuration example of an inference processing unit according to one or more aspects of the present disclosure.

FIG. 7 is a table for describing connection weights for states according to one or more aspects of the present disclosure.

FIG. 8 is a flowchart illustrating a processing example of an information processing apparatus according to one or more aspects of the present disclosure.

FIG. 9 is a diagram illustrating a configuration example of an inference processing unit according to one or more aspects of the present disclosure.

FIG. 10 is a table for describing delay values for states according to one or more aspects of the present disclosure.

FIG. 11 is a flowchart illustrating a processing example of an information processing apparatus according to one or more aspects of the present disclosure.

### DESCRIPTION OF THE EMBODIMENTS

Some embodiments of the present disclosure will now be described with reference to the drawings.

In the following, as an example of a use case to which an information processing apparatus according to each of the embodiments is applied, description will be given on the assumption of determination of the presence or absence of dangerous behavior using a monitoring camera. However, the use case is not limited to the determination of the presence or absence of dangerous behavior. The use case may be, for example, determination of the presence or absence of nuisance behavior, or detection of noise. In place of an inference model that outputs inference results of the presence or absence of dangerous behavior, an inference model trained to output inference results based on the use case can be used.

### First Embodiment

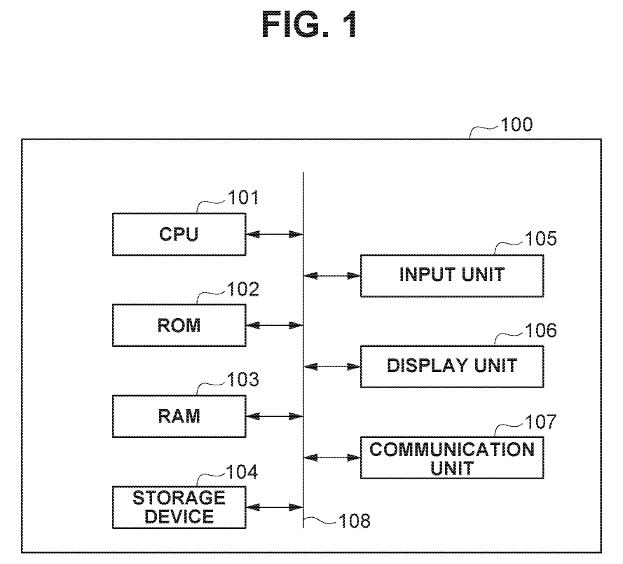

FIG. 1 is a diagram illustrating a hardware configuration example of an information processing apparatus according to a first embodiment.

An information processing apparatus 100 according to the present embodiment includes a central processing unit (CPU) 101, a read only memory (ROM) 102, a random access memory (RAM) 103, a storage device 104, an input unit 105, a display unit 106, a communication unit 107, and a system bus 108. The CPU 101, the ROM 102, the RAM 103, the storage device 104, the input unit 105, the display unit 106, and the communication unit 107 are communicably connected to each other via the system bus 108. The information processing apparatus 100 according to the present embodiment may further include a component other than these components.

The CPU 101 controls the entire information processing apparatus 100 using computer programs and data stored in the ROM 102 and the RAM 103 to carry out, for example, functions of the information processing apparatus 100 described below. By the CPU 101 loading programs read from the ROM 102 and the like into the RAM 103 to execute the programs, an inference processing unit, an acquisition unit, and a feature value output unit are implemented. The information processing apparatus 100 may include one or a plurality of pieces of dedicated hardware different from the CPU 101, and at least a part of the processing by the CPU 101 may be performed using the dedicated hardware. Examples of the dedicated hardware include an Application Specific Integrated Circuit (ASIC), a field programmable gate array (FPGA), a digital signal processor (DSP), and a graphics processing unit (GPU).

The ROM 102 stores programs and the like that do not require modification. The RAM 103 temporarily stores programs and data supplied from the storage device 104, and data and the like supplied from the outside via the communication unit 107. Further, the RAM 103 has a function as a main memory, a working area, and the like for the CPU 101. The storage device 104, which includes a hard disk drive (HDD) or a solid state drive (SSD), stores various types of data. The storage device 104 stores, for example, various types of data necessary with which the CPU 101 performs processing relating to the programs, and various types of data and the like obtained by the CPU 101 performing the processing relating to the programs.

The input unit 105, which includes, for example, a keyboard, a mouse, a joystick, or a touch panel, inputs various types of instructions to the CPU 101 in response to operations by a user. The display unit 106, which includes, for example, a liquid crystal display or a light-emitting diode (LED), shows the user display images. The display unit 106 displays, for example, a graphical user interface (GUI) with which the user operates the information processing apparatus 100, and processing results from the CPU 101. The input unit 105 and the display unit 106 may be provided as separate devices outside the information processing apparatus 100. The communication unit 107 connects the information processing apparatus 100 to a network to control communication with another device and the like.

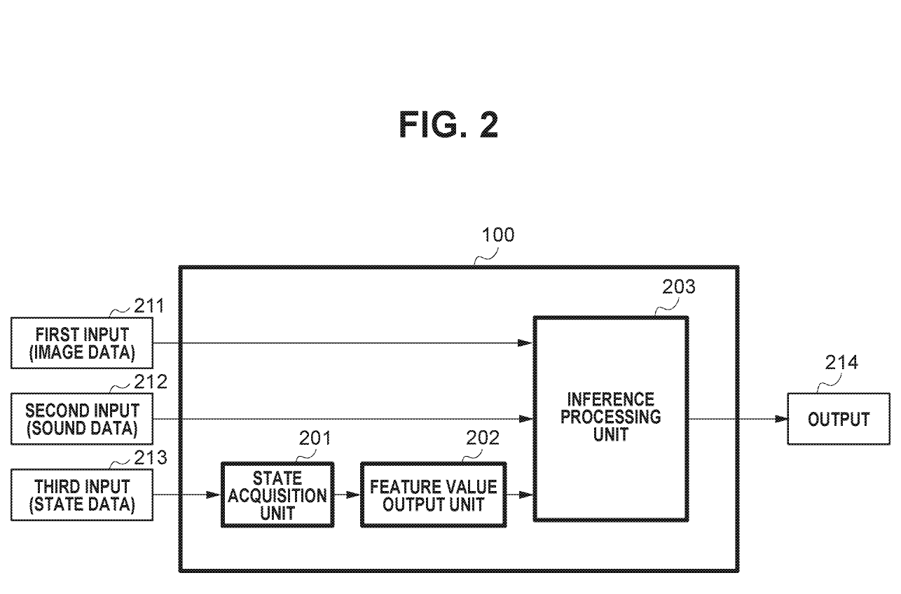

FIG. 2 is a diagram illustrating a functional configuration example of the information processing apparatus 100 according to the present embodiment. The information processing apparatus 100 according to the present embodiment generally performs inference processing based on a plurality of inputs to output an inference result. In the present embodiment, image data is input as a first input 211, sound data is input as a second input 212, and an inference result is output as an output 214. In the following, the first input and the second input are respectively described as the image data and the sound data.

The information processing apparatus 100 includes a state acquisition unit 201, a feature value output unit 202, and an inference processing unit 203. The state acquisition unit 201 obtains, as a zoom state, the state of an angle of view related to imaging with a monitoring camera through zoom operations, such as a zoom-in operation and a zoom-out operation, when the user appropriately operates the angle of view with respect to a subject of interest based on state data input as a third input 213. The state acquisition unit 201 obtains information about the zoom state resulting from a zoom operation, such as enlarging (zoom-in) or reducing (zoom-out) a point of focus on a captured image. In this case, the point of focus refers to, for example, the center of an angle of view in optical zoom, and the center of an image after zooming in electronic zoom (digital zoom). The obtained information about the zoom state is output to the feature value output unit 202.

The feature value output unit 202 controls inference processing performed by the inference processing unit 203 based on the zoom state. In the present embodiment, the feature value output unit 202 determines which model to select as an inference model used for the inference processing performed by the inference processing unit 203 based on the zoom state, and then outputs a determination result as a feature value to the inference processing unit 203. The determination method will be described below.

The inference processing unit 203 receives the first input (the image data) 211, the second input (the sound data) 212, and the output (the feature value) of the feature value output unit 202, performs the inference processing based on the image data and the sound data, and then outputs the inference result as the output 214. The inference processing unit 203 performs inference computation processing on the image data and the sound data using an inference model for the output of the feature value output unit 202 to output the inference result. The inference result may be output to a storage via the bus inside the apparatus, or may be output to an external device via a communication network, such as the Internet. In the present embodiment, the inference processing unit 203 is capable of performing sum-of-products calculation and nonlinear processing, which are employed in general neural network models.

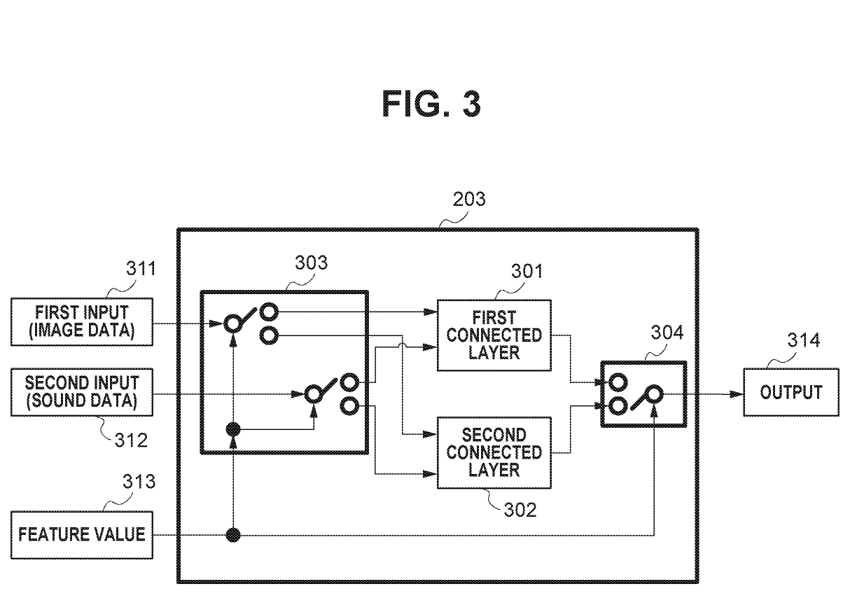

FIG. 3 is a diagram illustrating a configuration example of the inference processing unit 203 according to the present embodiment. The inference processing unit 203 includes, for example, a convolutional neural network (CNN). While CNN processing generally includes bias addition and nonlinear processing, details thereof will be omitted in the present embodiment. However, the configuration of the neural network is not limited to the CNN in the present embodiment, and may include computation, such as fully connected processing. The computation method itself of the neural network is a well-known technique, and thus, description thereof will be omitted.

The inference processing unit 203 includes a first connected layer 301, a second connected layer 302, an image sound selection unit 303, and a result selection unit 304. The inference processing unit 203 receives a first input (image data) 311, a second input (sound data) 312, and a feature value 313, performs the inference processing based on the image data and the sound data, and then outputs an inference result as an output 314. The first input (the image data) 311 and the second input (the sound data) 312 correspond to the first input (the image data) 211 and the second input (the sound data) 212, which are input to the information processing apparatus 100, respectively, and the feature value 313 is an output of the feature value output unit 202.

The first connected layer 301 and the second connected layer 302 are inference models that receive the image data 311 and the sound data 312 as inputs, perform inference through computation of the neural network, and then output an inference result of the presence or absence of dangerous behavior. These inference models can be created by performing training using, for example, image data and sound data as input data and the presence or absence of dangerous behavior as teacher data. The first connected layer 301 is an inference model trained to perform inference while the sound data is emphasized with a large distance between an imaging plane and a subject, whereas the second connected layer 302 is an inference model trained to perform inference while the sound data is emphasized with a small distance between the imaging plane and the subject. In other words, the first connected layer 301 is trained to perform inference that emphasizes sound at a position distant from the imaging plane, whereas the second connected layer 302 is trained to perform inference that emphasizes sound at a position close to the imaging plane. The inference models of the first connected layer 301 and the second connected layer 302 may differ in the amount of computation involved in inference processing, and may also differ in the layer configuration (the number of layers) or the number of nodes in the neural network. Thus, the first connected layer 301 and the second connected layer 302 are not required to have the same layer configuration or the same number of nodes, and may have a layer configuration (number of layers) and the number of nodes enough to perform inference optimized for the respective conditions.

The image sound selection unit 303 outputs the input image data 311 and the input sound data 312 to either the first connected layer 301 or the second connected layer 302 based on the feature value 313 output from the feature value output unit 202. The result selection unit 304 outputs, as the inference result, the output of a connected layer selected between the first connected layer 301 and the second connected layer 302 based on the feature value 313 output from the feature value output unit 202. In other words, the image sound selection unit 303 and the result selection unit 304 select the inference model of the same connected layer based on the feature value 313. Further, it is sufficient for either the first connected layer 301 or the second connected layer 302 selected by the image sound selection unit 303 and the result selection unit 304 to operate.

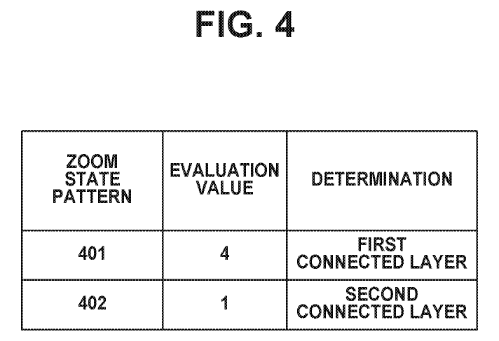

A method will now be described in which the feature value output unit 202 determines the inference model to be selected by the image sound selection unit 303 and the result selection unit 304 based on the information about the zoom state input from the state acquisition unit 201 with reference to FIG. 4. FIG. 4 is a table illustrating an example of selecting an inference model by using an evaluation value for a zoom state pattern and a predetermined threshold according to the present embodiment.

The state acquisition unit 201, for example, calculates an evaluation value for a distance between the imaging plane and the subject of interest within the range of zero to four as values based on the input zoom state by setting the smallest zoom magnification of the monitoring camera to a minimum value of zero and the largest zoom magnification to a maximum value of four. Thus, the evaluation value is calculated so that a larger value indicates a farther distance to the subject of interest, and a smaller value indicates a closer distance to the subject of interest.

In the present embodiment, the feature value output unit 202, as an example, sets the predetermined threshold to three and compares the evaluation value with the threshold, determining which connected layer to select in the inference processing unit 203. When the evaluation value is three or more, the feature value output unit 202 determines that the first connected layer 301 is selected, whereas when the evaluation value is less than three, the feature value output unit 202 determines that the second connected layer 302 is selected. The feature value output unit 202 then outputs the feature value 313 corresponding to the result of the determination. In the example illustrated in FIG. 4, in the case of a zoom state pattern 401, the feature value output unit 202 selects the first connected layer 301 because the evaluation value is four, which is greater than the threshold of three. In the case of a zoom state pattern 402, the feature value output unit 202 selects the second connected layer 302 because the evaluation value is one, which is less than the threshold of three.

In determination of the presence or absence of dangerous behavior using the monitoring camera, which is described as the use case in the present embodiment, it is desirable for a sound source to be in the vicinity of the subject. Thus, it is desirable for an inference model that determines by emphasizing sound from a long distance to be selected for the first connected layer 301, and for an inference model that determines by emphasizing sound from a short distance to be selected for the second connected layer 302. The determination method is not limited to the above-described method, and any method can be employed as long as the method can determine the distance between the imaging plane and the subject.

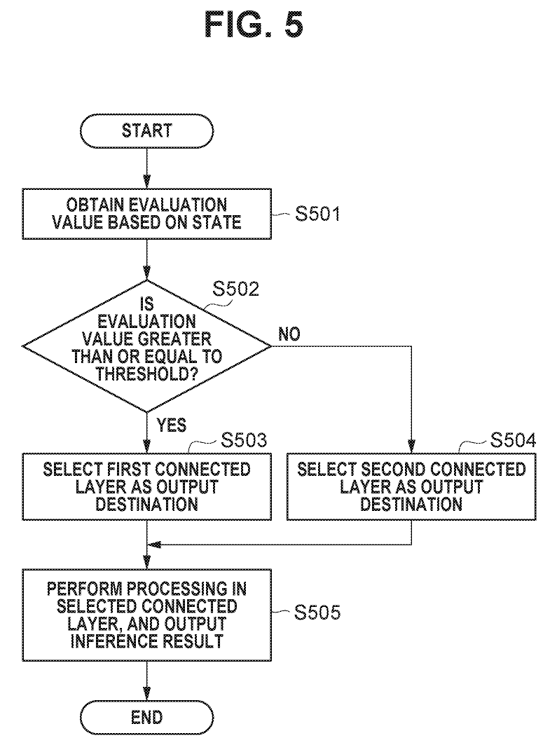

FIG. 5 is a flowchart illustrating a processing example of the information processing apparatus 100 according to the first embodiment. The processing of the flowchart illustrated in FIG. 5 is performed, for example, by the CPU 101 of the information processing apparatus 100 executing programs and the like loaded into the RAM 103. The information processing apparatus 100 starts the processing of the flowchart illustrated in FIG. 5 by inputting image data as the first input 211 and sound data as the second input 212.

In step S501, the CPU 101 obtains an evaluation value for the distance between the imaging plane and the subject of interest based on the zoom state of the monitoring camera. The evaluation value is set to be a value between a minimum value of zero and a maximum value of four as described above.

In step S502, the CPU 101 determines whether the evaluation value obtained in step S501 is greater than or equal to a predetermined threshold. In other words, the CPU 101 compares the evaluation value and the threshold to determine the inference model to be used for inference related to determination of the presence or absence of dangerous behavior using the monitoring camera based on the evaluation value obtained in step S501. If the CPU 101 determines that the evaluation value is greater than or equal to the threshold (YES in step S502), the processing proceeds to step S503. In contrast, if the CPU 101 determines that the evaluation value is less than the threshold (NO in step S502), the processing proceeds to step S504.

In step S503, the CPU 101 selects the first connected layer 301 as the output destination for the image data and the sound data, and then outputs the feature value corresponding thereto. In other words, the CPU 101 selects the first connected layer 301 as the output destination, which corresponds to the evaluation value for the distance between the imaging plane and the subject, of the image data and the sound data as the input data. After the processing is performed in step S503, the processing proceeds to step S505.

In step S504, the CPU 101 selects the second connected layer 302 as the output destination of the image data and the sound data, and then outputs the feature value corresponding thereto. In other words, the CPU 101 selects the second connected layer 302 as the output destination, which corresponds to the evaluation value for the distance between the imaging plane and the subject, of the image data and the sound data as the input data. After the processing is performed in step S504, the processing proceeds to step S505.

In step S505, the CPU 101 performs computation (inference processing) of the neural network in the first connected layer 301 or the second connected layer 302 selected in step S503 or S504, and then outputs an inference result of the presence or absence of dangerous behavior using the monitoring camera.

In the above-described manner, the information processing apparatus 100 according to the present embodiment selects an inference model that performs the inference processing by using the zoom state of the monitoring camera as the evaluation value. As a result, inference can be performed while sound in the vicinity of the subject selected by the user is emphasized. This makes it possible to perform inference using the image and the sound that are highly related to the subject, increasing accuracy of the inference.

In the above description, the example is described in which the inference processing unit 203 includes the two inference models as the first connected layer 301 and the second connected layer 302. However, the inference models are not limited thereto. The inference processing unit 203 may include three or more inference models, and may perform inference processing by selecting one suitable inference model from among the three or more inference models based on an evaluation value for the distance between the imaging plane and a subject of interest based on a zoom state.

### Second Embodiment

A second embodiment will be described. A hardware configuration and a functional configuration of an information processing apparatus 100 according to the present embodiment are similar to those of the information processing apparatus 100 according to the first embodiment illustrated in FIG. 1 and FIG. 2. Thus, the description thereof will be omitted. Differences from the above-described first embodiment will be described in the following.

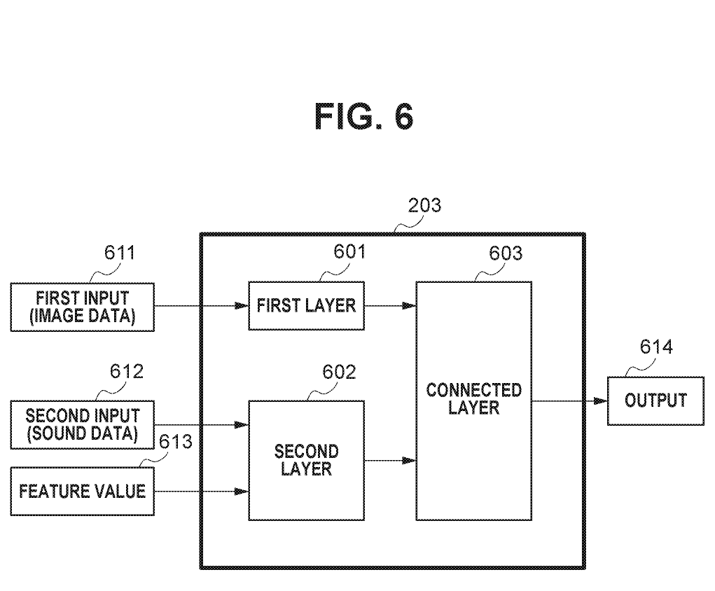

FIG. 6 is a diagram illustrating a configuration example of the inference processing unit 203 according to the present embodiment. The inference processing unit 203 according to the present embodiment includes, for example, a CNN as with the above-described first embodiment. However, in the present embodiment, the configuration of the neural network is not limited to the CNN, and may include computation, such as fully connected processing.

The inference processing unit 203 according to the second embodiment includes a first layer 601, a second layer 602, and a connected layer 603. The inference processing unit 203 receives a first input (image data) 611, a second input (sound data) 612, and a feature value 613, performs inference processing based on the image data and the sound data, and then outputs an inference result as an output 614. The first input (the image data) 611 and the second input (the sound data) 612 correspond to the first input (image data) 211 and the second input (sound data) 212, which are input to the information processing apparatus 100, respectively, and the feature value 613 is an output of the feature value output unit 202.

The first layer 601 is an inference model that receives the image data 611 as an input, infers the presence or absence of dangerous behavior by computation of the neural network, and then outputs an inference result to the connected layer 603. The inference model can be created by performing training using, for example, the image data as input data and the presence or absence of dangerous behavior as teacher data.

The second layer 602 is an inference model that receives the feature value 613 output from the feature value output unit 202 and the sound data 612 as inputs, infers the presence or absence of dangerous behavior by computation of the neural network, and then outputs an inference result to the connected layer 603. The inference model can be created by performing training using, for example, the sound data as input data and the presence or absence of dangerous behavior as teacher data.

The connected layer 603 is a connected layer of an inference model that receives the inference result by the first layer 601 and the inference result of the second layer 602 as inputs, infers the presence or absence of dangerous behavior based on the image data and the sound data, and then outputs the inference result as a final inference result of the inference processing unit 203.

The first layer 601, the second layer 602, and the connected layer 603 may be collectively configured as one inference model. In a case where the first layer 601, the second layer 602, and the connected layer 603 are configured as one inference model, the outputs of the first layer 601 and the second layer 602 and the input of the connected layer 603 may be in a form of input or output necessary for connections between a plurality of nodes of an intermediate layer in the neural network.

In the present embodiment, a case will be described where a not-illustrated microphone serving as a unit configured to acquire sound data is in the vicinity of the imaging plane of the monitoring camera.

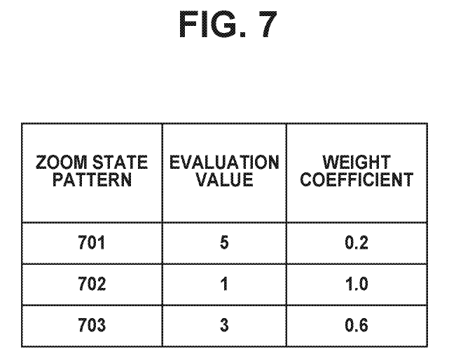

A method will be described in which the feature value output unit 202 outputs a feature value to the second layer 602 based on the information about a zoom state input from the state acquisition unit 201, and then the second layer 602 performs inference using the sound data based on the feature value with reference to FIG. 7. FIG. 7 is a table illustrating an example of the relationship between the evaluation value for zoom state pattern and the feature value input to the second layer 602 based on the evaluation value according to the present embodiment. In the present embodiment, the feature value refers to a coefficient of connection weight between nodes of the input layer and the intermediate layer in the second layer 602, and refers to the weight coefficient illustrated in FIG. 7.

For example, the state acquisition unit 201 calculates an evaluation value for the distance between the imaging plane and the subject of interest within the range of one to five as values based on the input zoom state by setting the smallest zoom magnification of the monitoring camera to a minimum value of one and the largest zoom magnification to a maximum value of five. Thus, the evaluation value is calculated so that a larger value indicates a farther distance to the subject of interest, and a smaller value indicates a closer distance to the subject of interest.

As illustrated in FIG. 7, in the case of a zoom state pattern 701 where the evaluation value is five, the distance from the imaging plane to the subject is large, and thus, there is a high possibility that sound data acquired in the vicinity of the imaging plane includes a large amount of sound that is not emitted from the vicinity of the subject. Thus, the feature value output unit 202 sets the weight coefficient as the feature value to 0.2, and adjusts the weight related to the sound data so as to put less emphasis on the sound data in the inference by the inference processing unit 203. In the case of a zoom state pattern 702 where the evaluation value is one, the distance from the imaging plane to the subject is small, and the subject and the microphone are positioned close to each other, and thus, there is a high possibility that sound data input to the second layer 602 includes a large amount sound emitted from the subject. Thus, the feature value output unit 202 determines that the sound data is valid information for inference, sets the weight coefficient as the feature value to 1.0, and adjusts the weight related to the sound data so as to use the sound data as is in the inference by the inference processing unit 203. In the case of a zoom state pattern 703 where the evaluation value is three, the distance from the imaging plane to the subject is intermediate. Therefore, the feature value output unit 202 sets the weight coefficient as the feature value to 0.6, and adjusts weight related to the sound data in the inference by the inference processing unit 203.

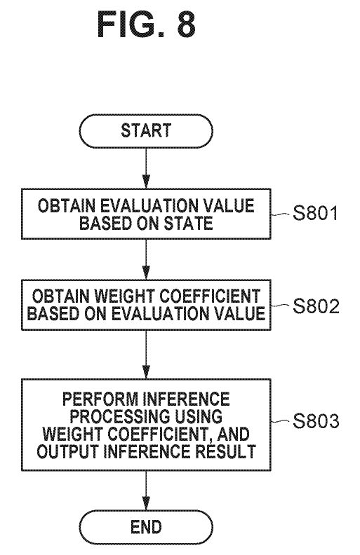

FIG. 8 is a flowchart illustrating a processing example of the information processing apparatus 100 according to the second embodiment. The processing of the flowchart illustrated in FIG. 8 is performed, for example, by the CPU 101 of the information processing apparatus 100 executing programs and the like loaded into the RAM 103. The information processing apparatus 100 starts the processing of the flowchart illustrated in FIG. 8 by inputting image data as the first input 611 and sound data as the second input 612.

In step S801, the CPU 101 obtains an evaluation value for the distance between the imaging plane and the subject of interest based on a zoom state of the monitoring camera. The evaluation value is set to be a value between a minimum value of one and a maximum value of five as described above.

In step S802, the CPU 101 obtains the weight coefficient as the coefficient of connection weight between nodes of the input layer and the intermediate layer in the second layer 602 based on the evaluation value obtained in step S801.

In step S803, the CPU 101 performs inference processing using the weight coefficient obtained in step S802, and then outputs an inference result of the presence or absence of dangerous behavior using the monitoring camera. Specifically, the CPU 101 performs inference in the second layer 602 by using the input sound data and the weight coefficient obtained in step S802. Further, in parallel with the inference in the second layer 602, the CPU 101 performs inference in the first layer 601 using the input image data. Furthermore, the CPU 101 performs inference using the inference results of the first layer 601 and the second layer 602 as inputs to the connected layer 603, and then outputs the obtained inference result as a final inference result regarding the presence or absence of dangerous behavior using the monitoring camera.

In the above-described manner, the information processing apparatus 100 according to the present embodiment controls the connection weight (the weight coefficient) between nodes in the neural network for the sound data based on the zoom state of the monitoring camera. This makes it possible to prevent decrease in inference accuracy caused by sound data likely to have low relevance to the subject, increasing inference accuracy based on the image and the sound.

In the present embodiment, the case is described in which the connection weight, which is assigned to the connection between nodes of the two layers in the second layer 602, is assigned to the connection between nodes of the input layer and the intermediate layer. However, assigning the connection weight is not limited thereto. For example, a connection weight based on an evaluation value may be set to the connection between nodes of other layers, or the connection between nodes of all layers of the entire second layer 602.

Further, during training of the second layer 602, an inference model subjected to training by using sound data and the evaluation value as inputs may be configured. For example, in the case of determination of the presence or absence of dangerous behavior using the monitoring camera, the training is performed so as to perform inference while sound in the vicinity of the subject is emphasized based on the zoom state. Performing training in the above-described manner enables the second layer 602 to constantly perform inference using sound data having high relevance to the subject. This makes it possible to increase accuracy of the inference result of the entire inference processing unit 203.

### Third Embodiment

A third embodiment will be described. A hardware configuration and a functional configuration of an information processing apparatus 100 according to the present embodiment are similar to those of the information processing apparatus 100 according to the first embodiment illustrated in FIG. 1 and FIG. 2. Thus, the description thereof will be omitted. Differences from the above-described first embodiment will be described in the following.

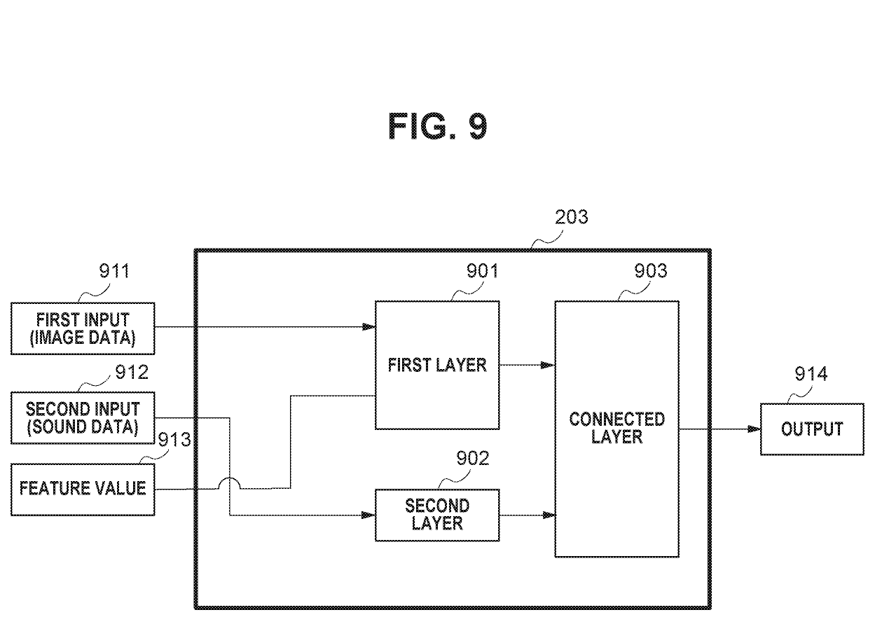

FIG. 9 is a diagram illustrating a configuration example of an inference processing unit 203 according to the present embodiment. The inference processing unit 203 according to the present embodiment includes, for example, a recurrent neural network (RNN). While RNN processing generally includes bias addition and nonlinear processing, details thereof will be omitted in the present embodiment. However, in the present embodiment, the configuration of the neural network is not limited to the RNN, and may include computation, such as fully connected processing.

The inference processing unit 203 according to the third embodiment includes a first layer 901, a second layer 902, and a connected layer 903. The inference processing unit 203 receives a first input (image data) 911, a second input (sound data) 912, and a feature value 913, performs inference processing based on the image data and the sound data, and then outputs an inference result as an output 914. The first input (the image data) 911 and the second input (the sound data) 912 correspond to the first input (image data) 211 and the second input (sound data) 212 input to the information processing apparatus 100, respectively, and the feature value 913 is an output of the feature value output unit 202.

The first layer 901 is an inference model that receives the feature value 913 output from the feature value output unit 202 and the image data 911, infers the presence or absence of dangerous behavior using computation of the neural network, and then outputs an inference result to the connected layer 903. The inference model can be created by performing training using, for example, the image data as input data and the presence or absence of dangerous behavior as teacher data.

The second layer 902 is an inference model that receives the sound data 912, infers the presence or absence of dangerous behavior using computation of the neural network, and then outputs an inference result to the connected layer 903. The inference model can be created by performing training using, for example, the sound data as input data and the presence or absence of dangerous behavior as teacher data.

The connected layer 903 is a connected layer of an inference model that receives the inference result by the first layer 901 and the inference result of the second layer 902 as inputs, infers the presence or absence of dangerous behavior based on the image data and the sound data, and then outputs the inference result as a final inference result of the information processing apparatus 100.

The first layer 901, the second layer 902, and the connected layer 903 may be collectively configured as one inference model. In a case where the first layer 901, the second layer 902, and the connected layer 903 are configured as one inference model, the outputs of the first layer 901 and the second layer 902 and the input of the connected layer 903 may be in a form of input or output necessary for connection of the plurality of nodes of an intermediate layer in the neural network.

In the present embodiment, a case is described where a not-illustrated microphone serving as a unit configured to acquire sound data is in the vicinity of the imaging plane of the monitoring camera.

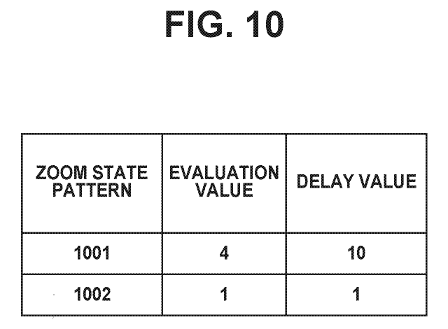

A method will be described in which a feature value output unit 202 outputs a feature value to the first layer 901 based on the information about a zoom state input from a state acquisition unit 201, and then the first layer 901 performs inference using the image data based on the feature value with reference to FIG. 10. FIG. 10 is a table illustrating evaluation values for zoom state patterns and delay values obtained based on the evaluation values according to the present embodiment. A delay value obtained based on an evaluation value refers to the time difference between a time when optical information about the subject is received on the imaging plane and a time when sound data emitted from the subject at the same timing is captured by the microphone. The optical information is received on the imaging plane almost instantaneously, whereas the speed of sound transmission is approximately 340 meters per second. Thus, the time difference occurs between the acquired image and the sound. In other words, in a case where inference is performed on the subject distant from the imaging plane, when inference is performed using image data and sound data received at the same timing, an inference result is output based on the image data and the sound data having low temporal correlation, decreasing inference accuracy.

The state acquisition unit 201, for example, calculates an evaluation value for a distance between the imaging plane and the subject of interest within the range of zero to four as values based on the input zoom state by setting the smallest zoom magnification of the monitoring camera to a minimum value of zero and the largest zoom magnification to a maximum value of four. Thus, the evaluation value is calculated so that a larger value indicates a farther distance to the subject of interest, and a smaller value indicates a closer distance to the subject of interest.

As illustrated in FIG. 10, in the case of a zoom state pattern 1001 where the evaluation value is four, the distance from the imaging plane to the subject is large, and thus, delay of the sound data emitted from the vicinity of the subject is large. Thus, the feature value output unit 202 sets the delay value as the feature value to ten. In the case of a zoom state pattern 1002 where the evaluation value is one, the distance from the imaging plane to the subject is small, and thus, delay of the sound data emitted from the vicinity of the subject is small. Thus, the feature value output unit 202 sets the delay value as the feature value to one.

In the present embodiment, the first layer 901 recursively performs computation of the neural network based on the delay value output as the feature value from the feature value output unit 202. In the case of a large delay value, the number of times the computation is recursively performed increases, whereas in the case of a small delay value, the number of times the computation is recursively performed decreases.

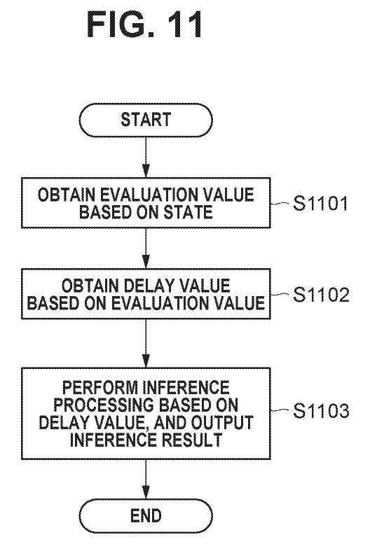

FIG. 11 is a flowchart illustrating a processing example of the information processing apparatus 100 according to the third embodiment. The processing of the flowchart illustrated in FIG. 11 is performed, for example, by the CPU 101 of the information processing apparatus 100 executing programs and the like loaded into the RAM 103. The information processing apparatus 100 starts the processing of the flowchart illustrated in FIG. 11 by inputting image data as the first input 911 and sound data as the second input 912.

In step S1101, the CPU 101 calculates an evaluation value for the distance between the imaging plane and the subject of interest based on the zoom state of the monitoring camera. The evaluation value is set to be a value between a minimum value of zero and a maximum value of four as described above.

In step S1102, the CPU 101 obtains the delay value based on the evaluation value obtained in step S1101.

In step S1103, the CPU 101 performs inference processing based on the delay value obtained in step S1102, and then outputs an inference result of the presence or absence of dangerous behavior using the monitoring camera. Specifically, the CPU 101 recursively performs inference on the image data in the first layer 901 using the input image data based on the delay value obtained in step S1102. Further, in parallel with inference in the first layer 901, the CPU 101 performs inference in the second layer 902 using the input sound data. Furthermore, the CPU 101 performs inference using the inference results of the first layer 901 and the second layer 902 as inputs to the connected layer 903, and then outputs the obtained result as a final inference result regarding the presence or absence of dangerous behavior using the monitoring camera.

In the above-described manner, the information processing apparatus 100 according to the present embodiment can perform inference on the image data by recursively executing computations based on the delay value, enabling inference using the image data and the sound data with high temporal affinity. This makes it possible to increase inference accuracy. Further, performing the inference processing using the RNN enables prediction in a time direction on the inference of the image data, which also increases inference accuracy of the prediction in the time direction.

The method has been described in which recursive inference is performed on the first layer 901. However, the method is not limited thereto, and any method can be employed as long as the method enhances the temporal affinity between the image data about the subject and the sound data emitted from the vicinity of the subject. For example, inference may be performed using the input image data after a delay time. Because it is difficult to perform prediction in the time direction using this method, the deep learning technique using the neural network can be configured using the CNN.

### Other Embodiments of Present Disclosure

The present disclosure can be implemented by supplying a program for carrying out one or more functions of the above-described embodiments to a system or an apparatus through a network or a storage medium, and causing one or more processors in a computer of the system or the apparatus to read and execute the program. Further, the present disclosure can be implemented by a circuit (e.g., ASIC) carrying out one or more functions.

The above-described embodiments are merely examples to implement the present disclosure, and the technical scope of the present disclosure is not to be restrictively interpreted by the above-described embodiments. In other words, the present disclosure can be implemented in various forms without departing from the technical idea or the main features of the present disclosure.

The disclosure of the embodiments includes the following configurations, a method, and the like.

### Configuration 1

An information processing apparatus that performs inference processing using a neural network, the information processing apparatus comprising:

an inference processing unit configured to perform the inference processing using a plurality of pieces of input data including an image and sound as inputs; and

an acquisition unit configured to obtain information about a zoom state in capturing of the image,

wherein the inference processing unit controls the inference processing using at least one of the plurality of pieces of input data based on the obtained information about the zoom state.

### Configuration 2

The information processing apparatus according to configuration 1, further comprising a feature value output unit configured to output a feature value corresponding to a distance between an imaging plane of the image and a subject of interest in the image based on the obtained information about the zoom state,

wherein the inference processing unit controls the inference processing using at least one of the plurality of pieces of input data based on the feature value.

### Configuration 3

The information processing apparatus according to configuration 1 or 2, wherein the inference processing unit controls the inference processing using the image including a subject of interest and the sound emitted from a vicinity of the subject.

### Configuration 4

The information processing apparatus according to any one of configurations 1 to 3, wherein the inference processing unit includes a plurality of inference models each configured to perform the inference processing, and performs the inference processing by selecting one of the inference models based on the obtained information about the zoom state.

### Configuration 5

The information processing apparatus according to configuration 4, wherein the plurality of inference models is different in an amount of computation in the inference processing.

### Configuration 6

The information processing apparatus according to configuration 4, wherein the plurality of inference models is different in at least one of a number of layers and a number of nodes in computation of the neural network.

### Configuration 7

The information processing apparatus according to any one of configurations 1 to 3, wherein the inference processing unit controls a connection weight between nodes in the neural network that performs the inference processing using at least one of the plurality of pieces of input data based on the obtained information about the zoom state.

### Configuration 8

The information processing apparatus according to configuration 7, wherein the connection weight between the nodes in the neural network is controlled based on a distance between an imaging plane of the image and a subject of interest in the image.

### Configuration 9

The information processing apparatus according to any one of configurations 1 to 3, wherein the inference processing unit controls inference processing using first input data based on delay of second input data with respect to the first input data based on the obtained information about the zoom state.

### Configuration 10

The information processing apparatus according to configuration 9, wherein the inference processing unit performs computation of a recurrent neural network using the first input data based on the delay of the second input data with respect to the first input data.

### Method

A method for controlling an information processing apparatus that performs inference processing using a neural network, the method comprising:

performing the inference processing using a plurality of pieces of input data including an image and sound as inputs; and

obtaining information about a zoom state in capturing of the image,

wherein the inference processing using at least one of the plurality of pieces of input data is controlled based on the obtained information about the zoom state.

### Program

A program that causes a computer to function as each unit of the information processing apparatus according to any one of configurations 1 to 10.

According to the embodiments, accuracy of inference using a neural network to which an image and sound are input can be increased.

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-016303, filed February 3, 2025, which is hereby incorporated by reference herein in its entirety.

What is claimed is:

1. An information processing apparatus that performs inference processing using a neural network, the information processing apparatus comprising:
an inference processing unit configured to perform the inference processing using a plurality of pieces of input data including an image and sound as inputs; and
an acquisition unit configured to obtain information about a zoom state in capturing of the image,
wherein the inference processing unit controls the inference processing using at least one of the plurality of pieces of input data based on the obtained information about the zoom state.

2. The information processing apparatus according to claim 1, further comprising a feature value output unit configured to output a feature value corresponding to a distance between an imaging plane of the image and a subject of interest in the image based on the obtained information about the zoom state,
wherein the inference processing unit controls the inference processing using at least one of the plurality of pieces of input data based on the feature value.

3. The information processing apparatus according to claim 1, wherein the inference processing unit controls the inference processing using the image including a subject of interest and the sound emitted from a vicinity of the subject.

4. The information processing apparatus according to claim 1, wherein the inference processing unit includes a plurality of inference models each configured to perform the inference processing, and performs the inference processing by selecting one of the inference models based on the obtained information about the zoom state.

5. The information processing apparatus according to claim 4, wherein the plurality of inference models is different in an amount of computation in the inference processing.

6. The information processing apparatus according to claim 4, wherein the plurality of inference models is different in at least one of a number of layers and a number of nodes in computation of the neural network.

7. The information processing apparatus according to claim 1, wherein the inference processing unit controls a connection weight between nodes in the neural network that performs the inference processing using at least one of the plurality of pieces of input data based on the obtained information about the zoom state.

8. The information processing apparatus according to claim 7, wherein the connection weight between the nodes in the neural network is controlled based on a distance between an imaging plane of the image and a subject of interest in the image.

9. The information processing apparatus according to claim 1, wherein the inference processing unit controls inference processing using first input data based on delay of second input data with respect to the first input data based on the obtained information about the zoom state.

10. The information processing apparatus according to claim 9, wherein the inference processing unit performs computation of a recurrent neural network using the first input data based on the delay of the second input data with respect to the first input data.

11. A method for controlling an information processing apparatus that performs inference processing using a neural network, the method comprising:
performing the inference processing using a plurality of pieces of input data including an image and sound as inputs; and
obtaining information about a zoom state in capturing of the image,
wherein the inference processing using at least one of the plurality of pieces of input data is controlled based on the obtained information about the zoom state.

12. A non-transitory computer-readable storage medium storing a program that causes a computer to execute a method for controlling an information processing apparatus that performs inference processing using a neural network, the method comprising:
performing the inference processing using a plurality of pieces of input data including an image and sound as inputs; and
obtaining information about a zoom state in capturing of the image,
wherein the inference processing using at least one of the plurality of pieces of input data is controlled based on the obtained information about the zoom state.
